(19) United States
(12) Patent Application Publication
(10) Pub. No.: US 2026/0110630 A1
(43) Pub. Date: Apr. 23, 2026

(54) METHODS AND SYSTEMS FOR OPEN PATH GAS DETECTION

(71) Applicant: INSIGHT M INC., Sunnyvale, CA (US)

(72) Inventors: Alexander Michael Wolff, Palo Alto, CA (US); Matthew Austin Cocca, San Francisco, CA (US); Michael R. Matthews, Portola Valley, CA (US); Elena SF Berman, Mountain View, CA (US); Erin Blake Wetherley, Oakland, CA (US); Harshil Mayur Kamdar, Cambridge, MA (US); Neil Christopher McFadden, San Francisco, CA (US); Todd L. Gustavson, Sunnyvale, CA (US)

(73) Assignee: INSIGHT M INC., Sunnyvale, CA (US)

(21) Appl. No.: 18/924,530

(22) Filed: Oct. 23, 2024

(51) Int. Cl. G01N 21/31

(52) U.S. Cl. CPC G01N 21/31; G01N 2201/06113; G01N 2201/127

(57) ABSTRACT

A system for open-path gas detection may include a first laser emitter having a first wavelength overlapping with two or more absorption features in a spectrum of a gas, a second laser emitter having a second wavelength centered away from the two or more absorption features in the spectrum of the gas, wherein a first laser beam including light from the first laser and a second laser beam including light from the second laser are combined in a single combined laser beam, wherein the combined laser beam is directed at a target to determine an amount of the gas between the system and the target, and signal processing circuitry configured to extract a first received power of the first laser beam and a second received power of the second laser beam from the combined laser beam.

### TECHNICAL FIELD

The embodiments described herein relate to open path gas detection and/or quantification.

### BACKGROUND

There are primarily two existing families of methods for open path gas detection and quantification using laser illumination. Both utilize laser sources with substantially narrower linewidth than individual gas absorption features.

The first family of methods relies on scanning the frequency of a tunable laser source to map out the absorption of one or more gas absorption lines. There are broadly two different ways to measure gas concentrations in this method: tunable diode laser absorption spectroscopy (TDLAS) and wavelength modulation spectroscopy (WMS).

The second family of methods, differential absorption LiDAR (DIAL), relies on measuring the returned laser power at two different set wavelengths: an absorption line (the “on” wavelength) and a nearby spectral region of no absorption (the “off” wavelength). The difference between the transmitted and received powers of the two beams allows for the calculation of the path integrated absorption of light.

Given the urgent need to reliably measure greenhouse gas emissions on large spatial scales, both DIAL and WMS/TDLAS-based instruments have recently been deployed on either or both of unmanned aerial vehicle (UAV)-based and manned airborne platforms. Laser-based approaches generally provide greater sensitivity as well as more flexible operations than other options, such as methods that rely on reflected sunlight illumination, since laser-based systems are less sensitive to weather considerations.

However, both of these families of systems require an expensive and complex laser source or optical amplifier to achieve a signal-to-noise ratio that is adequate for remote sensing measurements. Moreover, wavelength locking and linewidth calibration for these devices is extremely challenging due to atmospheric changes, mechanical stress, and vibration when performing airborne measurements.

### SUMMARY

A novel method and device are disclosed for the open path sensing of gas molecules. The embodiments described herein utilize much simpler laser sources than conventional systems. Systems and methods are disclosed using spectral regions with dense spectral absorption lines where an application of simpler laser sources is possible.

### BRIEF DESCRIPTION OF THE DRAWINGS

The accompanying drawings constitute a part of this specification and illustrate embodiments of the subject matter disclosed herein.

FIG. 1 illustrates an example environment for open-path gas detection and quantification.

FIG. 2 is a block diagram illustrating an example system for open-path gas detection and quantification.

FIG. 3 is a spectrum graph illustrating a portion of a transmittance spectrum for methane gas.

FIG. 4 is a spectrum graph illustrating on-line and off-line wavelengths for a laser having a linewidth of 0.2 nm on the transmittance spectrum for methane gas.

FIG. 5 is a spectrum graph showing a transmittance spectrum of methane gas using an effective resolution of the linewidth used in FIG. 4 and showing the on-line wavelength and off-line wavelength of FIG. 4.

FIG. 6 is a spectrum graph illustrating on-line and off-line wavelengths for a laser having a linewidth of 1 nm on the transmittance spectrum for carbon dioxide gas.

FIG. 7 is a spectrum graph showing a transmittance spectrum of carbon dioxide gas using an effective resolution of the linewidth used in FIG. 6 and showing the on-line wavelength and off-line wavelength of FIG. 6.

FIG. 8 is a block diagram of an example system for combining laser beams having a same wavelength using polarization.

FIG. 9 illustrates an example system for combining laser beams having different wavelengths using spatial overlap and providing a sample of light from the resulting laser beam for analysis.

FIG. 10 is a block diagram of an example system for extracting optical parameters from a combined laser beam.

FIG. 11 is a block diagram of an example system for open-path gas detection and quantification.

FIG. 12 is a flowchart illustrating operations of a method for open-path gas detection and quantification.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

The embodiments described herein provide a method and system which give the benefits of prior laser-based approaches with a much simpler laser source. In the absorption spectrum of a variety of gas molecules there are regions of closely spaced absorption lines. In TDLAS and WMS-based approaches, these regions have largely been avoided for measurements as it is difficult to accurately fit the resulting measured returns due to the complexity of the absorption spectra. In DIAL-based approaches, these regions have largely been avoided for measurement as it is difficult to accurately provide “on” and “off” wavelengths due to the closely spaced nature of the lines. In addition, the absorption may not drop to zero in between these lines making it difficult to make an accurate measurement. An “on” wavelength is a laser wavelength which is on an absorption line. An “off” wavelength is a laser wavelength which is not on an absorption line. Comparing the absorption of the “on” wavelength to the absorption of the “off” wavelength allows for the calculation of the path-integrated absorption of the laser radiation.

Example embodiments utilize a portion of a region of closely spaced absorption features for the “on” wavelength and a region nearby for the “off” wavelength. By comparing absorption of the “on” region to absorption of the “off” region, information about the gas may be determined.

Moreover, implementations and examples discussed herein provide for combining a laser beam having an “on” wavelength and a laser beam having an “off” wavelength into a single combined laser beam. By combining the laser beams into the single combined laser beam, the combined laser beam can be directed through the air and reflected back to measure the impact of the gasses in the air on the combined laser beam and on both wavelengths. As the two components (two wavelengths) of the combined laser beam pass through the exact same space (i.e., they are colinear), they can be compared directly to detect and/or quantify a gas the combined laser beam passed through. The same approach can be used by combining more than two laser beams having wavelengths centered on portions of a gas spectrum that provide additional information and/or certainty as to the identity and/or quantity of the gas the combined laser beam passes through.

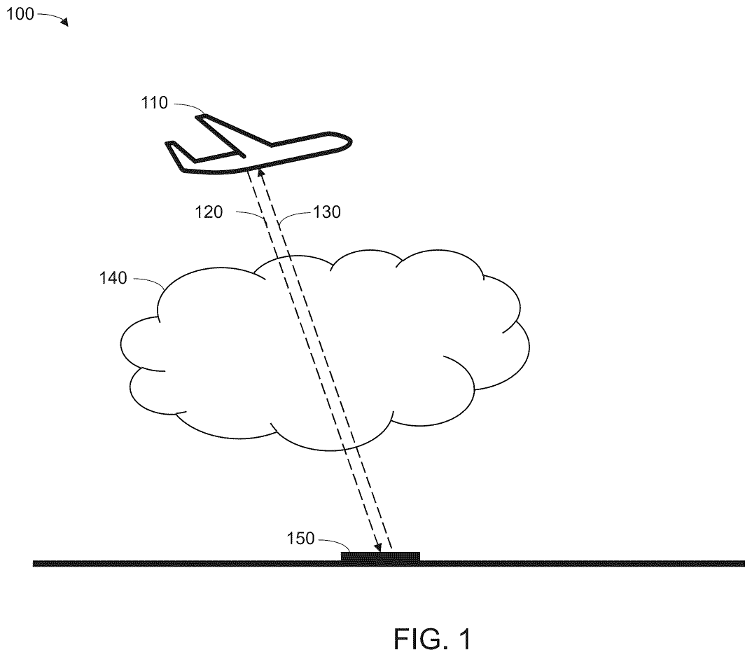

FIG. 1 illustrates an example environment 100 for open-path gas detection and quantification. A transmitted laser beam 120 can be emitted from an aircraft 110 and a received laser beam 130 can be received at the aircraft 110. For case of discussion, the light received at the aircraft 110 that originated in the transmitted laser beam 120 is referred to as the received laser beam 130. However, the received light may no longer be collimated (i.e., is not a fully collimated laser beam). The transmitted laser beam 120 can be directed through a gas 140 toward a target 150. The target 150 can be the ground, an object, or any surface from which the transmitted laser beam 120 can be reflected. The transmitted laser beam 120 is reflected off the target 150 and travels back to the aircraft 110 as the received laser beam 130. As the transmitted laser beam 120 and the received laser beam 130 travel through the gas 140, a portion of the transmitted laser beam 120 and a portion of the received laser beam 130 are absorbed by the gas 140. By comparing the power of the transmitted laser beam 120 to the power of the received laser beam 130, an amount of the gas 140 between the aircraft 110 and the target 150 can be detected and quantified.

The transmitted laser beam 120 can be a combined laser beam that is formed by combining a first laser beam having a wavelength centered on one or more absorption features in the spectrum of the gas 140 and a second laser beam having a wavelength centered away from any absorption features in the spectrum of the gas 140 such that the first laser beam would lose power due to passing through the gas 140 while the second laser beam would not lose power due to passing through the gas. As used herein, “combining” laser beams into a combined laser beam refers to making the laser beams sufficiently collinear to be treated as a single laser beam (e.g., directed using mirrors, lenses, etc.). By combining the first laser beam and the second laser beam in the combined laser beam, both laser beams pass through the exact same portion of the gas 140, reducing differences due to reflection off the target 150, spectral interaction, gas concentration, aerosols in the air, and other factors inherent in different portions of air. The components of the combined laser beam from the first laser beam and the second laser beam can be extracted from the received laser beam 130 to determine a difference between the received power of the first laser beam and the second laser beam. As the first laser beam is more strongly affected by the gas 140 than the second laser beam, the gas 140 can be quantified using the difference or ratio between the received power of the first laser beam and the second laser beam.

While the example environment 100 illustrates an aircraft 110 transmitting the transmitted laser beam 120 and receiving the received laser beam 130, the examples described herein allow for other implementations, such as other vehicle-mounted systems (truck-mounted, ship-mounted, UAV-mounted, and satellite systems) and stationary systems (tower-mounted, ground-mounted and infrastructure mounted). By using robust, broad-wavelength lasers, the examples described herein can be applied to a variety of different implementations.

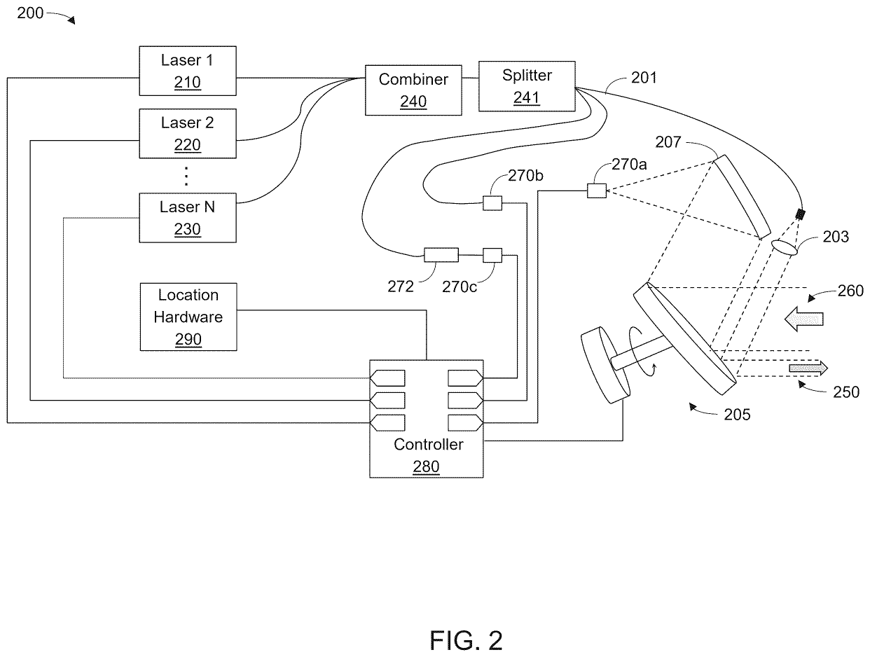

FIG. 2 is a block diagram illustrating an example system 200 for open-path gas detection and quantification. The system 200 may be implemented in the environment 100 of FIG. 1. In an example, the system 200 may be deployed on (e.g., mounted on, coupled to) the aircraft 110 of FIG. 1.

The system 200 includes a first laser emitter 210 and a second laser emitter 220. The system can include any number of additional laser emitters, including an nth laser 230. The first laser emitter 210 is configured to output a first laser beam, the second laser emitter 220 is configured to output a second laser beam, and the nth laser emitter 230 is configured to output an nth laser beam. The first laser emitter 210, the second laser 220, and the nth laser may be configured to output laser beams having linewidths of 0.1-5 nm. In some examples, the first laser emitter 210 has a different linewidth than the second laser emitter 220. For case of discussion, laser parameters of laser beams produced by the laser emitters may be attributed herein to the laser emitters. In some examples, the first laser emitter 210 may have a same linewidth as the second laser emitter 220. The linewidth of the first laser emitter 210 may be selected depending upon a width of a cluster of absorption features of a gas absorption spectrum. The first laser emitter 210 may have a first wavelength centered on the cluster of features and the second laser emitter 220 may have a second wavelength centered away from the cluster of features on a portion of the absorption spectrum of the gas having lower absorption than the cluster of features or approximately zero absorption. The nth laser emitter 230 may have a third wavelength different from the first wavelength and the second wavelength to provide increased accuracy to detection and/or quantification of the gas. In some implementations, the nth laser emitter 230 has a third wavelength centered away from the cluster of features on a second portion of the absorption spectrum of the gas having lower absorption than the cluster of features or approximately zero absorption. In some implementations, the nth laser emitter 230 has a third wavelength centered on the cluster of features. The linewidth of the first laser emitter 210 may depend upon the width of the cluster of features and the linewidth of the second laser emitter 220 may be unconstrained by the width of the cluster of features. In some examples, the first laser emitter 210, the second laser emitter 220, and the nth laser emitter 230 have the same linewidth to facilitate comparison of absorption of the first laser emitter 210, the second laser emitter 220, and the nth laser emitter 230. The wavelength of the first laser emitter 210 may be an “on” wavelength, as it is centered on the cluster of features, and the wavelength of the second laser emitter 220 may be an “off” wavelength, as it is centered off of the cluster of features. The wavelength of the nth laser emitter 230 may be an “on” wavelength or an “off” wavelength.

The system includes a combiner 240. The combiner 240 receives and combines laser beams from the first laser emitter 210, the second laser emitter 220, up to the nth laser emitter 230. The combiner 240 may combine the laser beams from the laser emitters 210, 220, 230 in a single combined laser beam in a single optical fiber 201. The combined laser beam travels through the single optical fiber 201 to a lens 203 that directs the combined laser beam onto a steering mirror 205. The steering mirror 205 directs the combined laser beam out of the system 200. The combined laser beam may be directed at an area or at a target, such as the target 150 of FIG. 1, as a transmitted laser beam 250. The combined laser beam may be reflected back to the system (e.g., reflected off the target) and received at the system 200 as received reflected light 260. The received reflected light 260 may have a lower power than the transmitted laser beam 250, as a portion of the transmitted laser beam 250 was absorbed by a gas between the system 200 and the target. The received reflected light 260 may have a lower power than the transmitted laser beam 250 due to other losses, such as reflective losses, scatter from the target, absorption by aerosols or water vapor, and other factors.

The first laser emitter 210, the second laser emitter 220, and the nth laser emitter 230 are independently intensity modulated, using one or more different phases, frequencies, and patterns. These differences of the first laser emitter 210, the second laser emitter 220, and the nth laser emitter 230 may facilitate extracting the power of the first laser emitter 210, the second laser emitter 220, and the nth laser emitter 230 from the combined laser beam. In an implementation where more than one laser emitter is at the same wavelength, they will share the same phase, frequency or pattern form of modulation. For example, if laser emitters 210 and 230 are at the same wavelength, they may both have the same frequency and phase of intensity modulation so that the total power at the shared wavelength can be uniquely identified in the combined laser light 201, 250 and 260.

The received reflected light 260 is reflected off the steering mirror 205 onto the focusing optics 207 that directs and focuses the received reflected light 260 to a received power sensor 270a. The focusing optic 207 is shown as a concave mirror but in other implementations may include a combination of mirrors and lenses that function to focus light on the detector 270a. Often it may be advantageous to add a bandpass optical filter before the power sensor 270a. The filter attenuates light that is not in a narrow wavelength band which includes the laser wavelengths. The received power sensor 270a may be a photodetector. In some implementations, the received power sensor 270a is a linear photodetector. In an example, the received power sensor 270a is a PIN diode. In an example, the received power sensor 270a is an Indium Gallium Arsenide (InGaAs) linear detector. The received power sensor 270a may measure a power of the received reflected light 260. The received power sensor 270a may generate an electrical signal based on the power of the received reflected light 260, which electrical signal is used to measure the power of the received reflected light 260. The received power sensor 270a transmits the measured power (electrical signal based on the power) of the received reflected light 260 to a controller 280.

The steering mirror 250 is controlled by a motor connected through the motor shaft assembly. An encoder is used to determine the absolute position of the steering mirror 205 during operation. The encoder is also used by the controller to stabilize the rotation rate. The steering mirror position is used with location data from location hardware 290 for estimating a geolocation of the laser spot on the ground. In some implementations, the steering mirror 205 is positioned off-axis relative to the motor shaft assembly 208 in order to steer the laser beam across the target in a quasi-elliptical manner.

The controller 280 includes one or more processors and one or more non-transitory, computer-readable media for controlling components of the system 200 such as the laser emitters 210, 220, 230 and the steering mirror 205 and for detecting and/or quantifying an amount of gas using the measured power (electrical signal based on the power) of the received reflected light 260 from the received power sensor 270a. The controller 280 may include one or more application specific integrated circuits (ASICs), one or more field-programmable gate arrays (FPGAs), and other circuits, chips, and electronics for performing functions attributed to the controller 280 herein. The controller 280 may include a combination of hardware and software, as well as a combination of digital and analog components to control the components of the system 200 and detect and/or quantify the gas. In an example, the controller 280 includes an FPGA chip with either a soft processor core or a hard processor core.

The controller 280 receives the electrical signal corresponding to the power of the received reflected light 260 from the received power sensor 270a. The controller 280 may receive electrical signals from additional sensors. In some implementations, the controller 280 receives electrical signals from a reference power sensor 270b and a gas reference sensor 270c. The system 200 may include a beam splitter 241. The splitter 241 separates a small amount of power from the combined laser beam and directs the small amount of power to the reference power sensor 270b and the gas reference sensor 270c. The reference power sensor 270b may measure a power of the transmitted laser beam 250. The gas reference sensor 270c may measure a power of the transmitted laser beam 250 after it passes through a gas reference cell 272 which contains a calibrated sample of the same type of gas to be measured by the system 200. The splitter 241 and/or the combiner 240 may provide a portion of the combined laser beam to the reference power sensor 270b and the gas reference sensor 270c. In some implementations, an end of the single optical fiber 201 is terminated with a flat cleave such that a portion of the combined laser beam is reflected from the flat cleaved end and is provided via additional optical fibers to the reference power sensor 270b and the gas reference sensor 270c. In other implementations the beam splitter 241 may be used after combiner 240. Light from the beam splitter may be directed to the reference power sensor 270b and the gas reference sensor 270c. In another implementation a free-space beam splitter may be used after the beam exits the fiber and before or after collimating lens 203. Light from the free-space beam splitter may be directed to the reference power sensor 270b and the gas reference sensor 270c.

In some implementations, the reference power sensor 270b measures the power of the first laser beam and the second laser beam. The reference power sensor 270b may measure the power of the transmitted laser beam 250 over a first wavelength range (e.g., linewidth) of the first laser beam and measure the power of the transmitted laser beam 250 over a second wavelength range (e.g., linewidth) of the second laser beam. The controller 280 may extract the powers of the first and second laser beams by extracting the powers over the first range of wavelengths and second range of wavelengths, respectively. In some implementations, the reference power sensor 270b measures the power of the first and second laser beams by measuring the power of the transmitted laser beam at the wavelengths of the laser emitters 210, 220, 230.

The reference power sensor 270b may measure the power of the transmitted laser beam 250 by measuring the power of the portion of the combined laser beam that is provided to the reference power sensor 270b. The power of the transmitted laser beam 250 may be used by the controller 280 to detect/quantify the gas based on the difference between the power of the transmitted laser beam 250 and the received reflected light 260. Changes in the power measured by the gas reference sensor 270c can be used by the controller 280 to determine changes in absorption at each laser emitter's wavelength to the gas in the gas reference cell 272. The changes in the power measured by the gas reference sensor 170c can thus be used to measure the absorption by the gas reference cell 272 and that absorption can be used as calibration by the controller 280 in analyzing the received power measured by the received power sensor 270a. In an example, the gas reference cell 272 includes methane, and power measurements by the gas reference sensor 270c indicate changes in the absorption at each emitter's wavelength, based on changes in absorption by the methane in the gas reference cell 272. In this way, changes in wavelength (causing changes in absorption) can be accounted for by the controller 280 in detecting and/or quantifying the amount of gas based on absorption.

The controller 280 receives the measured powers (e.g., electrical signals corresponding to the measured powers) from the received power sensor 270a, the transmitted power sensor 270b, and the gas reference sensor 270c, (referred to herein collectively as the “sensors 270”). In some implementations, the controller 280 may detect and/or quantify an amount of the gas between the system 200 and the target based on the power of the received reflected light 260, as measured by the received power sensor 270a. In some implementations, the controller 280 may detect and/or quantify an amount of the gas between the system 200 and the target based on the power of the received reflected light 260, as measured by the received power sensor 270a, the power of the transmitted laser beam 250, as measured by the transmitted power sensor 270b, and/or the power of the combined laser beam after it passes through the gas reference cell 272, as measured by the gas reference sensor 270c. In an example, the controller 280 determines the amount of the gas based on the power of the received reflected light 260 by determining a difference between a received power of the first laser beam output by the first laser emitter 210 and a received power of the second laser beam output by the second laser emitter 220. In an example, the controller determines the amount of the gas based on the power of the received reflected light 260 and the power of the transmitted laser beam 250 by adjusting the received power of the first laser beam based on a transmitted power of the first laser beam, adjusting the received power of the second laser beam based on a transmitted power of the second laser beam, and determining a difference between the adjusted received power of the first laser beam and the adjusted received power of the second laser beam. In this way, the changes in the power of the transmitted laser beam 250 are accounted for in the detection and/or quantification of the gas. In an example, the controller determines the amount of the gas based on the power of the received reflected light 260, the power of the transmitted laser beam 250, and the power of the combined laser beam after it passes through the gas reference cell 272 by adjusting the received power of the first laser beam based on a transmitted power of the first laser beam, adjusting the received power of the second laser beam based on a transmitted power of the second laser beam, determining an absorption factor of the first laser beam based on the power of the combined laser beam after it passes through the gas reference cell 272, determining an absorption factor of the second laser beam based on the power of the combined laser beam after it passes through the gas reference cell 272, and determining a difference in absorption between the first laser beam and the second laser beam using the absorption factor of the first laser beam, the adjusted received power of the first laser beam, the absorption factor of the second laser beam, and the adjusted received power of the second laser beam.

In some implementations, the transmitted power sensor 270b and the gas reference sensor 270c are referred to as “monitors,” as they allow for monitoring of the power at each emitter's wavelength of the transmitted laser beam 250, allowing for normalization of the power and absorption by the gas. In some implementations, “monitors” may refer to the transmitted power sensor 270b and the gas reference sensor 270c combined with the controller 280. In this way, the monitors can refer to a combination of sensing and measurement. In an example, a first monitor can include the transmitted power sensor 270b and the controller 280, where the first monitor measures a power of the transmitted laser beam 250 (extracted powers of first and second laser beams) and a second monitor can include the gas reference sensor 270c and the controller 280, where the second monitor measures a calibrated absorption of the transmitted laser beam 250 (e.g., calibrated absorptions of the first and second laser beams). In some implementations, the measurement of power at the power sensor 270b at each emitter's wavelength can be used to change the laser emitter's electrical current to keep the power measured at 270b constant.

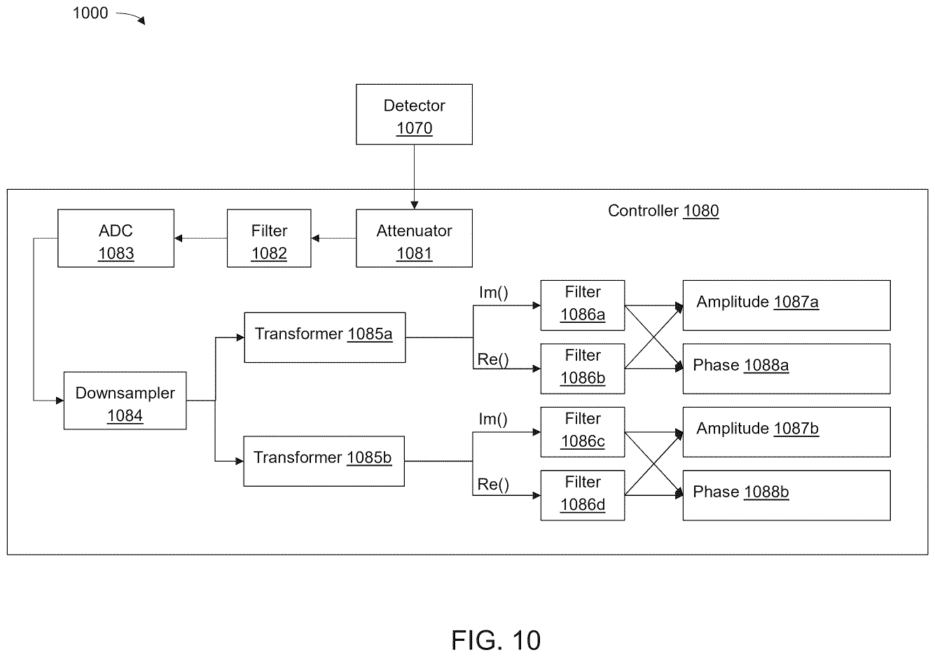

The controller 280 may include signal processing circuitry for extracting components of the combined laser beam and the reference beams. The signal processing circuitry may include a combination of hardware and software for extracting the components of the combined laser beam, such as portions of the power of the combined laser beam from the first laser beam, the second laser beam, and/or the nth laser beam, attributable to the first laser emitter 210, the second laser emitter 220, and/or the nth laser emitter 230, respectively. The signal processing circuitry may include one or more application specific integrated circuits (ASICs), one or more field-programmable gate arrays (FPGAs), and other circuits, chips, and electronics for performing signal processing to extract the power of the first laser beam, the second laser beam, and/or the nth laser beam from the received reflected light 260, the combined laser beam as received at the reference power sensor 270b, and the combined laser beam as received at the gas reference sensor 270c. In some implementations, the first laser beam, the second laser beam, and/or up to the nth laser beam have substantially orthogonal modulations relative to each other, allowing for electronic separation of the power of the first laser beam, the second laser beam, and/or up to the nth laser beam with a high signal to noise ratio. Details on how the signal processing circuitry extracts the components of the combined laser beam are described in FIG. 10.

The system 200 can include location hardware 290. The location hardware 290 may provide a geolocation to the controller 280. The location hardware 290 may include a global navigation satellite system (GNSS) and/or an inertial measurement unit (IMU) or inertial navigation system (INS). The location hardware 290 may include one or more accelerometers, magnetometers, and gyroscope sensors for determining a location of the system 200. The controller 280 can use the location of the system 200 to associate gas measurements with locations. The controller 280 can build a map of gas amounts associated with locations. The controller 280 can associate amounts of gas in columns of space (corresponding to the path of the transmitted laser beam 250) with geolocations. In an example, the controller 280 uses the geolocations from the location hardware 290 to generate a georeferenced methane column density map showing the spatial distribution of methane concentrations in an area.

In an example, the controller 280 uses data from the location hardware 290 to determine an earth centered position, altitude, heading, roll, pitch, and yaw of the system 200 and a current time. The controller 280 can take these determined values and combine them with a two-dimensional pointing direction of the transmitted laser beam 250 to determine the path of the transmitted laser beam 250 and the received reflected light 260. The two-dimensional pointing direction may be determined using a direction of the steering mirror 205 as measured by an encoder. Signals from the encoder can be correlated with a timing of the combined laser beam. In some implementations, the controller 280 can determine a location of the reflective spot on the ground based on terrain data or imaging of the ground. The controller 280 can correlate or otherwise associate the time and location data with sensor and laser emitter data so position, orientation, signal, and timing can all be correlated.

In some implementations, the controller 280 performs georeferencing in a two-step process. The first step involves generating an initial estimate of the latitude and longitude of the transmitted laser beam 250 projection on a target as a function of time using lab calibrations and system location relative to the target (e.g., sensor-plane-ground geometry). The second step involves using the OFF laser amplitude as a proxy for reflectivity. This signal provides a view of the ground and the albedo of the ground in the spectral region of the OFF laser. In some implementations, reference optical imagery can be used to refine the initial placement estimate. This reference optical imagery is most useful if it is of equal or higher resolution than the laser data and must cover the same area. In some implementations, keypoints and their descriptors in both sets of data (the laser data and the reference optical imagery) can be used to find common landmarks imaged in both datasets. In some implementations, techniques such as SIFT (Scale-Invariant Feature Transform) and SURF (Speeded Up Robust Features), and machine learning-based methods such as L2Net and SOSNet can be used to find common landmarks.

In some instances, the ground placement algorithm can be used as a generative model to create new estimates for the placement of the laser data. The ground placement algorithm can allow for potential misalignments or systematic errors in various parameters such as roll, pitch, yaw, and range. The ground placement algorithm can minimize the squared distance between the keypoints in the laser data and those in the reference imagery. By refining this alignment, the accuracy of the georeferencing can be significantly improved.

The controller 280 can provide modulation voltages to the first laser emitter 210, the second laser emitter 220, and the nth laser emitter 230 to control laser amplitude.

The first laser emitter 210, the second laser emitter 220, and/or the nth laser emitter 230 may be unstabilized (“open loop”) since the absorption signal is far less sensitive to the laser's center wavelength than conventional approaches. Unstabilized lasers are less expensive, require fewer optical and electronics components, and are more stable in the presence of thermal and mechanical changes. The system 200 may also include conventional noise-reducing capabilities inherent to other techniques such as in-phase and quadrature-phase detection of modulated frequency, phase and/or amplitude of the open loop laser sources.

Advantageously, the first laser emitter 210, the second laser emitter 220, and/or the nth laser emitter 230 can have a broad linewidth. Open loop laser sources can have much higher average power than the laser sources generally used for TDLAS, WMS, and conventional DIAL. The broad linewidth allows for open path gas detection and/or quantification at longer distances and/or higher sensitivities. Thus, the system 200 requires much less stringent center wavelength and linewidth stability than current methods, allowing for simpler, more robust systems for open path gas detection. For example, the need to “lock” a laser center wavelength to a particular absorption feature, as with conventional DIAL, is eliminated, allowing the elimination of the entire feedback system for “locking” the laser.

The system 200 moreover does not require a laser source to smoothly “scan” over a range of wavelengths as is required for TDLAS and WMS. The reduction in the stringency of the center wavelength and linewidth stability requirements makes the system 200 more amenable to harsh remote sensing environments such as airborne deployments. While the advantages will be most pronounced for open-path gas detection/quantification, the system 200 could also be used in a stationary implementation or with a closed gas cell.

In some examples, the first laser emitter 210, the second laser emitter 220, and/or the nth laser emitter 230 may be a Fabry-Perot diode laser emitter with optical external feedback that is wavelength selective. Other laser emitters could be implemented that use volume Bragg gratings or cats-eye reflectors with intracavity bandpass filters. The laser emitters may include extended cavity diodes in a Littrow configuration to narrow the diode linewidth. Littrow configurations allow the spectral width to be adjusted to the desired range by adjusting cavity parameters. As the laser emitter diodes (e.g., the first laser emitter 210, the second laser emitter 220, and/or the nth laser emitter 230) are multi-mode with a wide active region, the alignment requirements are less stringent relative to single-frequency lasers that are often associated with external feedback. Light from the laser emitter diodes (e.g., the first laser emitter 210, the second laser emitter 220, and/or the nth laser emitter 230) may be collimated by a lens having a focal length between 1 and 20 mm. The collimated output can then strike a diffraction grating, which may have a line spacing of between 300 and 1000 lines per millimeter. When placed at an angle corresponding to the Littrow configuration for the grating and a particular wavelength, light is diffracted back to the respective laser diode. This “feedback” light forces the diode to operate at the chosen wavelength. The chosen wavelength for each laser diode (e.g., the first laser emitter 210, the second laser emitter 220, and/or the nth laser emitter 230) can be set using a combination of temperature, laser current, grating alignment, and grating diffraction efficiency. Other optical properties, such as laser power, linewidth, and out-of-band power can be adjusted with the same parameters. For example, the grating line spacing determines the linewidth, where more lines equate to a narrower spectral width. The laser parameters may be selected to maintain low out-of-band power (or amplified spontaneous emission) and stability of the out-of-band fraction, as the out-of-band power does not contribute to gas measurement.

Lens selection may influence spectral width but not wavelength. The longer the focal length of a lens, the narrower the spectral width. Accordingly, a long focal length lens and high line count grating will give a narrower spectral width. Conversely, a short focal length lens and low line count rating will give a broader spectral width. By varying both of these components, a desired spectral width can be achieved.

Laser cavity parameters can be fine-tuned to obtain a target signal-to-noise ratio. The spectral width for a laser emitter may be chosen to maximize the signal-to-noise, or signal/noise ratio based on a combination of theoretical atmospheric simulations and laboratory experiments. A usable output beam can be obtained from the zeroth order (i.e., undiffracted) beam of the grating. It should be noted that any light which is diffracted and used as feedback may not be available in the output beam. This represents a loss when compared to the total output power that would be available without the lens/grating combination. The diffraction efficiency of the grating may be chosen so that there is sufficient light for feedback and subsequent wavelength locking but not an excessive amount which is subtracted from the usable output power. In an example, a diffraction efficiency of 10-30% may be chosen.

Moreover, the laser emitter may be frequency, phase and/or amplitude modulated by a waveform which enables the instrument to benefit from noise-reducing capabilities. Signal processing methods can be used to improve signal-to-noise, such as analog or digital modulation/demodulation, lock-in detection, or autocorrelation of waveforms. These filtering methods are possible because the waveform used to modulate the transmitted laser is known a-priori and can be correlated with the received signal thereby reducing the effect of noise due to solar photons, thermal noise generated in the detector, and other effects.

The example lasers discussed herein, represent a very simple, low cost, and robust laser source suitable for many applications. As opposed to standard DIAL and WMS-based methods which require careful wavelength and linewidth calibration and monitoring, the described example laser sources require little to no calibration once built. Many kinds of laser sources would be appropriate for the methods disclosed herein. In addition, although methane is used as an example herein, the disclosed methods are suitable for any gas (for e.g., carbon dioxide) which has the desired absorption spectrum properties.

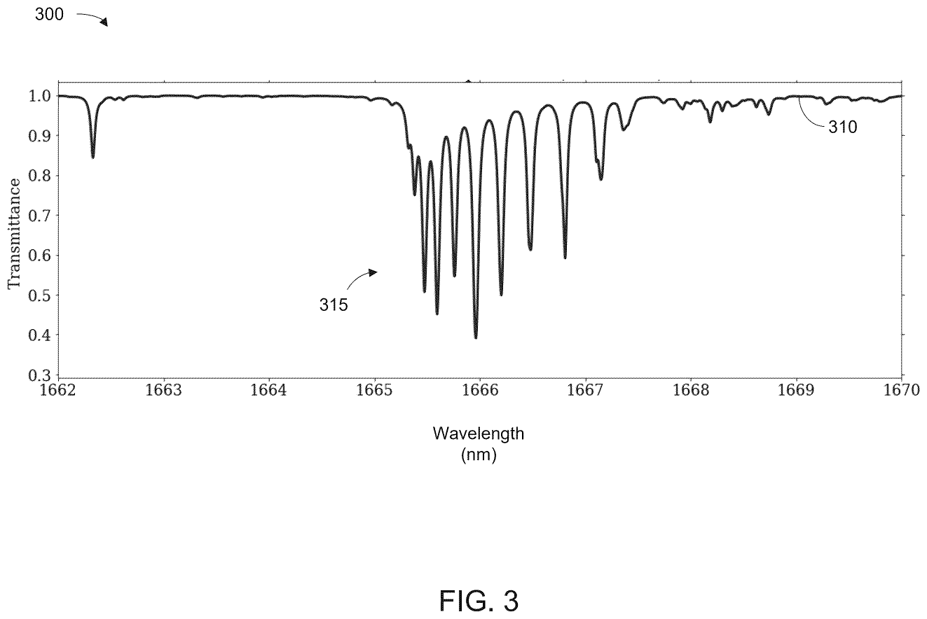

FIG. 3 is a spectrum graph 300 illustrating a portion of a transmittance spectrum 310 for methane gas. The transmittance spectrum 310 may show the transmittance of various wavelengths of light through methane gas. A portion of light traveling through the methane gas is absorbed, and the remainder of the light is transmitted. Thus, the absorption spectrum of methane complements the transmittance spectrum 310. Various wavelengths of light may be absorbed more than others. Wavelengths that are absorbed more than others may correspond to peaks on the absorption spectrum and troughs on the transmittance spectrum 310. The transmittance spectrum 310 may include a cluster of features 315. The cluster of features 315 may include a cluster of features or lines on the transmittance spectrum 310. The cluster of features 315 may include a cluster of troughs on the transmittance spectrum 315 corresponding to a cluster of peaks on the absorption spectrum.

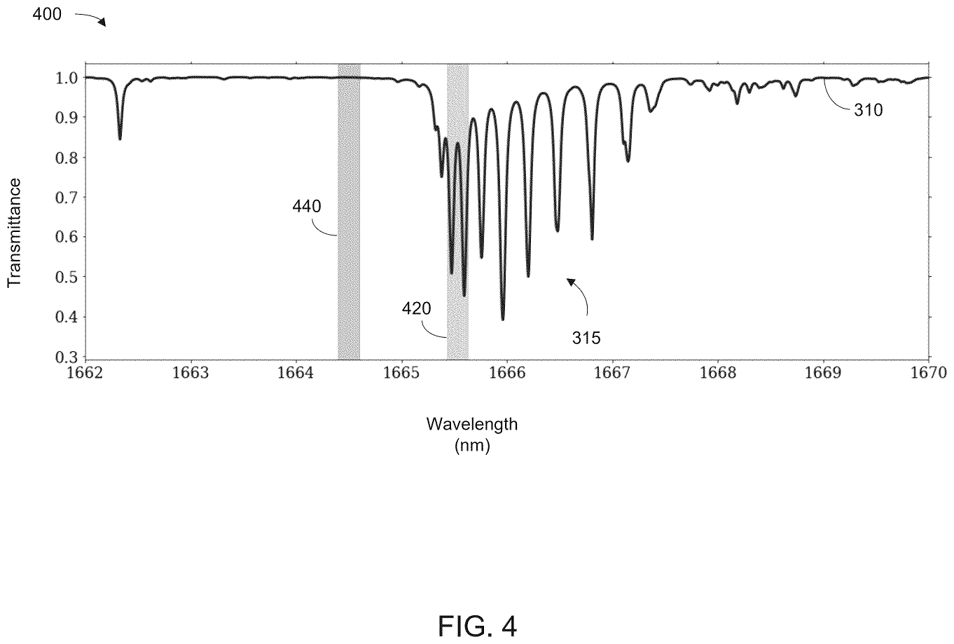

FIG. 4 is a spectrum graph 400 illustrating an on-line wavelength 420 and an off-line wavelength 440 for a laser having a linewidth of 0.2 nm on the transmittance spectrum 310 of FIG. 3 for methane gas. The on-line wavelength 420 may be centered on the cluster of features 315 or a portion of the cluster of features 315. The on-line wavelength 420 may cover a portion or an entirety of the cluster of features 315. The off-line wavelength 440 may be centered away from the cluster of features 315. The off-line wavelength 440 may be centered on a portion of the transmittance spectrum 310 having approximately full transmittance, or approximately zero absorption. Comparison of the transmittance or absorption at the on-line wavelength 420 and the off-line wavelength 440 can be used to detect and/or quantify methane gas, as discussed herein. In an example, the on-line wavelength 420 is the wavelength of the first laser emitter 210 of FIG. 2 and the off-line wavelength 440 is the wavelength of the second laser emitter 220 of FIG. 2.

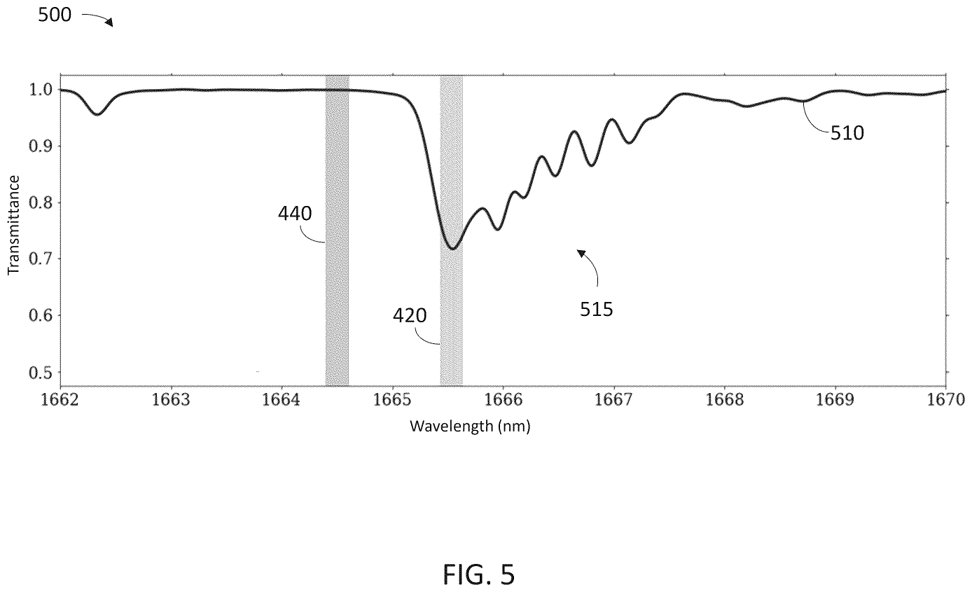

FIG. 5 is a spectrum graph 500 showing a transmittance spectrum 510 of methane gas using an effective resolution of the linewidth used in FIG. 4 and showing the on-line wavelength 420 and off-line wavelength 440 of FIG. 4. The transmittance spectrum 510 may be the transmittance spectrum of methane as recorded using a laser having a linewidth of 0.2 nm. Thus, the effective resolution of the transmittance spectrum 510 is lower than that of the transmittance spectrum 310. The transmittance spectrum 510 may include a cluster of features 515. The cluster of features 515 may correspond to the cluster of features 315 of FIG. 3, but with a lower resolution, such that the individual lines and troughs are not visible. The on-line wavelength 420 may be centered on the cluster of features 515 or a portion of the cluster of features 515. In an example, the on-line wavelength 420 may be centered on a portion of the cluster of features 515 having a lowest transmittance. In an example, the on-line wavelength 420 may be centered on a portion of the cluster of features 515 having a lowest transmittance at the effective resolution of the transmittance spectrum 510. The on-line wavelength 420 may correspond to a combination of transmissions for multiple features or lines.

Use of the on-line wavelength 420 having a linewidth corresponding to features of the cluster of features 515 instead of individual lines provides greater tolerance to shifts in the wavelength of a laser. For example, a laser having a wavelength centered on the on-line wavelength 420 and having a linewidth of 0.2 nm may fluctuate in its wavelength by 0.1 nm and still be centered on the cluster of features 515. In contrast, a laser having a linewidth of 0.01 nm and having a wavelength centered on one of the individual lines of the transmittance spectrum 310 cannot fluctuate in its wavelength by 0.1 nm without losing the individual line.

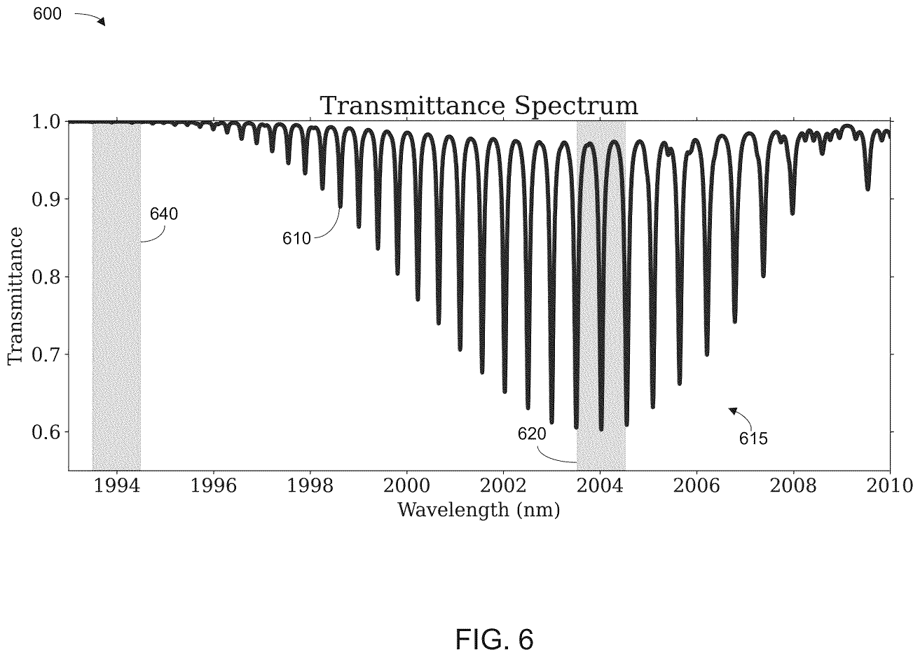

FIG. 6 is a spectrum graph 600 illustrating an on-line wavelength 620 and an off-line wavelength 640 for a laser having a linewidth of 1.0 nm on a transmittance spectrum 610 for carbon dioxide gas. The on-line wavelength 620 may be centered on a cluster of features 615 or a portion of the cluster of features 615 in the transmittance spectrum 610. The on-line wavelength 620 may cover a portion or an entirety of the cluster of features 615. The off-line wavelength 640 may be centered away from the cluster of features 615. The off-line wavelength 640 may be centered on a portion of the transmittance spectrum 310 having approximately full transmittance, or approximately zero absorption. Comparison of the transmittance or absorption at the on-line wavelength 620 and the off-line wavelength 640 can be used to detect and/or quantify carbon dioxide gas, as discussed herein. In an example, the on-line wavelength 620 is the wavelength of the first laser emitter 210 of FIG. 2 and the off-line wavelength 640 is the wavelength of the second laser emitter 220 of FIG. 1.

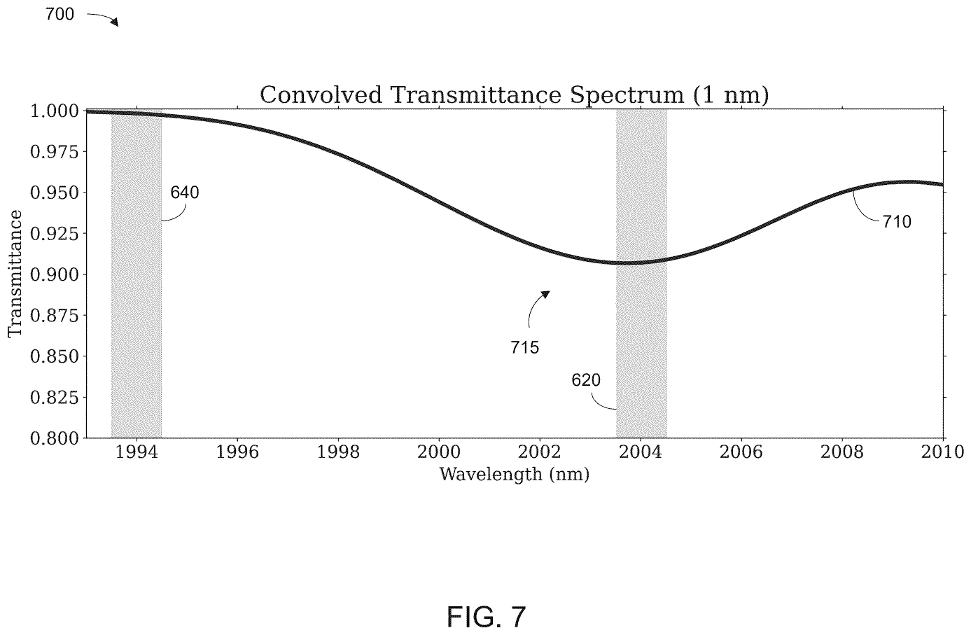

FIG. 7 is a spectrum graph 700 showing a transmittance spectrum 710 of carbon dioxide gas using an effective resolution of the linewidth used in FIG. 6 and showing the on-line wavelength 620 and off-line wavelength 640 of FIG. 6. The transmittance spectrum 710 may be the transmittance spectrum of carbon dioxide as recorded using a laser having a linewidth of 1.0 nm. Thus, the effective resolution of the transmittance spectrum 710 is lower than that of the transmittance spectrum 610. The transmittance spectrum 710 may include a cluster of features 715. The cluster of features 715 may correspond to the cluster of features 615 of FIG. 6, but with a lower resolution, such that the individual lines and troughs are not visible. The on-line wavelength 620 may be centered on the cluster of features 715 or a portion of the cluster of features 715. In an example, the on-line wavelength 620 may be centered on a portion of the cluster of features 715 having a lowest transmittance, corresponding to a highest absorption. In an example, the on-line wavelength 620 may be centered on a portion of the cluster of features 715 having a lowest transmittance at the effective resolution of the transmittance spectrum 710. The on-line wavelength 620 may correspond to a combination of transmissions for multiple features or lines.

Use of the on-line wavelength 620 having a linewidth corresponding to features of the cluster of features 715 instead of individual lines provides greater tolerance to shifts in the wavelength of a laser. For example, a laser having a wavelength centered on the on-line wavelength 620 and having a linewidth of 1 nm may fluctuate in its wavelength by approximately 2 nm and still overlap with the cluster of features 715 providing tolerable reduction in signal. In contrast, a laser having a linewidth of 0.01 nm and having a wavelength centered on one of the individual lines of the transmittance spectrum 310 cannot fluctuate in its wavelength by 2 nm without losing the individual line. Thus, the system 200 of FIG. 2 can avoid actively locking the frequency of the laser emitters 210, 220, 230 to resonance lines.

Using a laser with a spectral width in the 0.1-5 nanometer range enables the use of the combined absorption of many spectral lines simultaneously in a given spectral region for gas concentration measurements. Due to using a laser with a spectral width wider than a single absorption line, as opposed to conventional DIAL approaches, multiple absorption lines in a region of closely spaced absorption features may be used as the “on” or “on-line” wavelength. The relative difference between the absorption at the “on-line” wavelength and the “off-line” wavelength is not as great as when single transmission lines are used. However, a larger spectral width allows for the use of lasers having higher average power than lasers used in conventional DIAL approaches, making the absolute difference between absorption at the “on-line” wavelength and absorption at the “off-line” wavelength larger and compensating, at least partially, for the lower relative difference in absorption.

The spectral width of the laser used may depend upon the gas or gasses to be detected as well as specific clusters of absorption features of the gas. Lasers with spectral widths from 0.1 to 5 nanometers may be used. This larger flexibility in the desired linewidth opens the possibility for less complex and easier to operate laser sources that do not require amplification. As noted above, laser sources can be used having greater average power than laser sources used in conventional DIAL applications. Thus, while absorption from a cluster of absorption lines is lower than absorption from a single absorption line, an acceptable signal/noise ratio may be achieved due to the greater average power of the laser source.

Utilizing a laser having a linewidth of 0.1 to 2 or even 5 nanometers offers the technical improvement of allowing for simpler, more robust lasers to be used as compared to conventional systems. This improvement offers a distinct advantage in UAV and/or aerial-platform based systems, where temperature changes and vibration may introduce errors into absorption measurements. Simpler, more robust lasers, the use of which is enabled by the present disclosure, are less affected by the heat and vibration of UAV and/or manned aerial-platform based systems than more complex, less robust lasers. An example for such a laser source that can provide an appropriate spectral output may be a Fabry-Perot diode laser with external optical feedback that is wavelength selective. Other laser sources may also be used for this application.

The specific wavelengths and linewidths shown in FIGS. 4-7 are provided as examples and are not limiting. Different wavelengths corresponding to different features in spectra of different gasses may be used. Similarly, different linewidths corresponding to the widths of features in the spectra of the different gasses, or corresponding to different laser architectures, may be used.

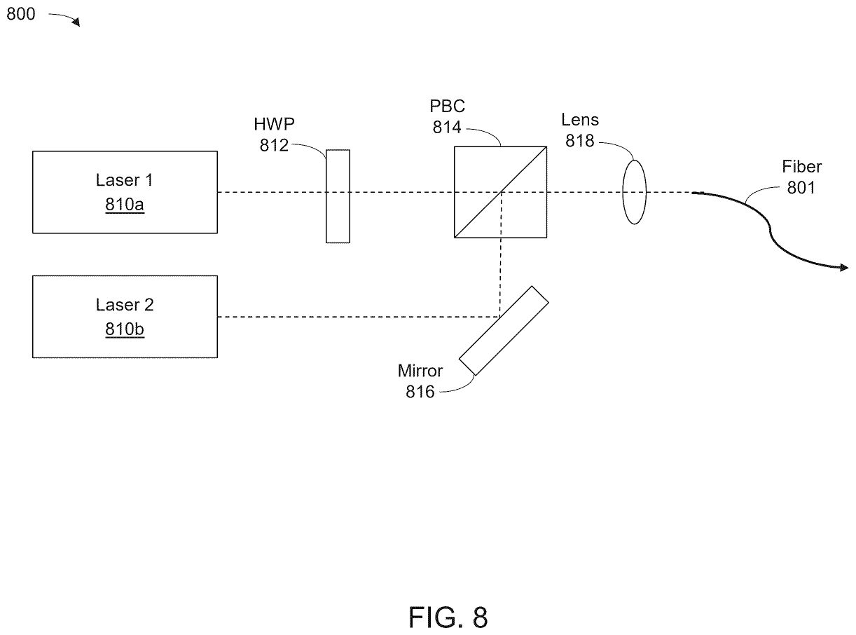

FIG. 8 is a block diagram of an example system 800 for combining laser beams having a same or different wavelength using polarization. The system 800 includes a first laser emitter 810a and a second laser emitter 810b, referred to collectively as the laser emitters 810 . . . . The laser emitters 810 may emit identical or nearly identical laser beams that are combined to produce a laser beam of higher power.

The laser beam from the first laser emitter 810a may pass through a half-wave-plate 812 to rotate the plane of polarization of the laser beam from the first laser emitter 810a such that the polarization of the laser beams from the laser emitters 810 are orthogonal to each other. The laser beams from the laser emitters 810 pass through a polarizing beam combiner 814 and a lens 818 to enter an optical fiber 801. The resulting laser beam has a higher power than the laser beams emitted by each of the laser emitters 810 individually, allowing for more robust measurement, as discussed herein.

The system 800 may be implemented in one or more instances in the system 200 of FIG. 2. For example, each of the first laser emitter 210, the second laser emitter 220, and the nth laser emitter 230 can include two or more laser emitters as in the system 800. In an example, the system 200 includes two instances of the system 800: one represented by the first laser emitter 210 and one represented by the second laser emitter 220.

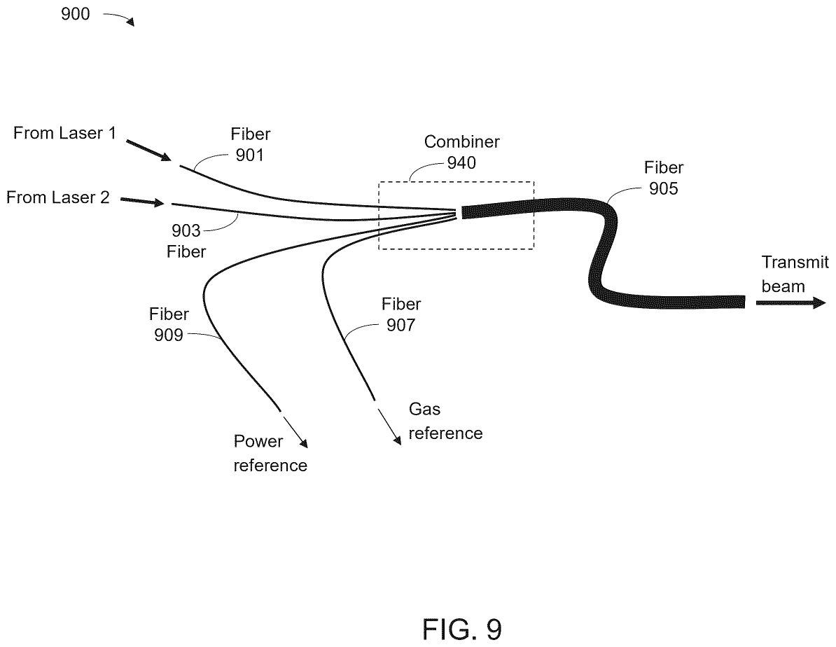

FIG. 9 illustrates an example system 900 for combining laser beams having different wavelengths using spatial overlap and providing a sample of light from the resulting laser beam for analysis. The different laser beams can each be emitted from different laser emitters, or from different systems of laser emitters, such as the system 800 of FIG. 8. The system 900 includes a first input fiber 901 and a second input fiber 903 through which input laser beams travel to a combiner 940. The combiner 940 may be the combiner 240 of FIG. 2, and the first input fiber 901 and the second input fiber 903 may connect the first laser emitter 210 and the second laser emitter 220, respectively, to the combiner 240 of FIG. 2. The combiner 940 may combine the input laser beams in a single transmission optical fiber 905. In one implementation, the combiner 940 is a common commercial multimode fiber combiner which physically packs input fibers 901, 903, 907 and 909 within the acceptance angle and position of the fiber 905. The single transmission optical fiber 905 may be the single optical fiber 201 of FIG. 2. The single transmission optical fiber 905 is a single multimode fiber having a larger numerical aperture and/or larger core size than the first input fiber 901 and the second input fiber 903. The single transmission optical fiber 905 may be terminated with a flat cleave, causing a small amount of light to reflect from the flat cleaved end and travel back through the single transmission optical fiber 905 to a first reference fiber 907 and a second reference fiber 909. The first reference fiber 907 and the second reference fiber 909 may connect to the power reference sensor 270b and the gas reference sensor 270c of FIG. 2, respectively. Using the reflection from the end of the single transmission fiber 905 makes the measurements by the power reference sensor 270b and the gas reference sensor 270c less sensitive to changes in light polarization and fiber mode distribution.

Other configurations for sampling the combined laser beam can be used. In some implementations, the combiner 940 is followed by a multimode beam splitter, such as the splitter 241 of FIG. 2. Two fibers of the same type are butt coupled with a small misalignment. A third fiber is placed next to the displaced output fiber such that a portion of the combined laser beam is coupled into the third fiber. The ratio of power in the two output fibers is determined by the relative overlap with the input fiber, and can be adjusted. In the case for sampling the power, a small tap (such as 1%) can be used. This approach has the advantage of simplicity of measurement and the advantage that all the fibers can be the same.

In some implementations, the output fiber 905 is coupled into free space and partial mirrors are used to sample a small fraction of the light. A properly coated piece of glass may serve as a beamsplitter and reflect a small amount of light, which can be sent into the first reference fiber 907 and the second reference fiber 909, or directly into the power reference sensor 270b and the gas reference sensor 270c of FIG. 2. Most of the light will be transmitted through the beamsplitter and can be transmitted directly as beam 250, or recoupled into the single transmission fiber 905 for output. The advantages of this approach are high power handling and that the coating may be adjusted for the desired sampling fraction. In this case fibers 907 and 909 can be repurposed as more inputs for additional laser emitters.

FIG. 10 is a block diagram of an example system 1000 for extracting the laser power at each wavelength from a combined laser beam. The system 1000 includes a detector 1070 and a controller 1080. The system 1000 may be implemented in the system 200. The controller 1080 may be the controller 280 of FIG. 2 and the detector 1070 may be any of the sensors 270 of FIG. 2. The controller 1080 is illustrated as extracting components from a power of a combined laser beam including two laser wavelengths, but the controller 1080 can extract components from a power of a combined laser beam including any number of laser beams. Each channel (i.e., constituent laser beam wavelength) of the combined laser beam has a distinct intensity modulation frequency (e.g., on frequency, off frequency) and phase. The distinct frequencies and phases may allow for extraction of the power of the different channels from the combined laser beam. Controller 1080 may use standard lock-in detection methods as shown. In other implementations controller 1080 may use autocorrelation methods to extract the power and delay of each channel. The controller 1080 can extract components from a power of a combined laser beam as generated and/or as reflected from a target, as discussed herein.

The controller includes an attenuator 1081, a high-pass filter 1082, and an analog-to-digital converter (ADC) 1083. In some implementations, the attenuator 1081, the high-pass filter 1082, and the ADC 1083 are analog processing components of the controller 1080, while other components of the controller 1080 are digital processing components of the controller 1080. The attenuator 1081 may reduce a power of the signal from the detector 1070 by a known amount. The high-pass filter 1082 may filter out low-frequency noise from the signal from the attenuator 1081. The ADC 1083 may convert the analog signals received from the high-pass filter 1082 into digital signals. In some implementations, the controller 1080 does not include the attenuator 1081 and/or the high-pass filter 1082.

The controller may include a downsampler 1084 that receives the digital signals from the ADC 1083 at a higher frequency and uses a low pass filter and downsampling to reduce the sampling rate to an appropriate frequency. In some embodiments, the downsampler 1084 can be implemented using a cascaded integrated comb filter, which may be followed by a compensation filter to flatten the passband if desired. The downsampler 1084 can provide the interpolated digital signals to a first transformer 1085a and a second transformer 1085b, referred to herein collectively as the transformers 1085. The first transformer 1085a can multiply the digital signals by exp (−2πi*fₒₙ*t) to determine a real portion and an imaginary portion of a first channel (i.e., “on-line” modulation frequency channel, first laser beam), where fₒₙ is the “on-line” modulation frequency, and t is time. The second transformer 1085b can multiply the digital signals by exp (−2πi*f_{off}*t) to determine a real portion and an imaginary portion of a second channel (i.e., “off-line” modulation frequency channel, second laser beam), where f_{off} is the “off-line” modulation frequency. As discussed herein, the different channels can be adequately orthogonal to each other, providing noise and cross-talk suppression to enhance a signal-to-noise ratio of the extracted signals.

A first low-pass filter 1086a and a second low-pass filter 1086b are applied to the imaginary and real portions, respectively, of the first channel to determine an amplitude of the first channel 1087a (e.g., power of the first channel, power of the first laser beam encoded at the ‘on-line’ modulation frequency) and a phase of the first channel 1088a (e.g., phase of the first channel, phase of the first laser beam encoded at the ‘on-line’ modulation frequency). In some implementations, the amplitude is determined using a sum of the squares of the outputs of the first low-pass filter 1086a and the second low-pass filter 1086b, and the phase is determined using a tangent of the ratio of the outputs of the first low-pass filter 1086a and the second low-pass filter 1086b. A third low-pass filter 1086c and a fourth low-pass filter 1086d are applied to the imaginary and real portions, respectively, of the second channel to determine an amplitude of the second channel 1087b (e.g., power of the second channel, power of the second laser beam encoded at the ‘off-line’ modulation frequency) and a phase of the second channel 1088b (e.g., phase of the second channel, phase of the second laser beam encoded at the ‘off-line’ modulation frequency). In this way, the controller 1080 can extract the amplitude and phase of each channel (i.e., constituent laser beam wavelength) in the combined laser beam. In some implementations, the amplitude is determined using a sum of the squares of the outputs of the third low-pass filter 1086c and the fourth low-pass filter 1086d, and the phase is determined using a tangent of the ratio of the outputs of the third low-pass filter 1086c and the fourth low-pass filter 1086d. In some implementations, auto-correlation functions may be used to determine the modulation patterns in order to determine the power and delay of each first and second laser beam.

The “on-line” and “off-line” modulation frequencies may be constrained by the signal extraction performed by the controller 1080, or by the signal processing circuitry of the controller 1080. In some implementations, the “on-line” and “off-line” frequencies are constrained by Expressions 1 and 2, where N is a number of samples to average, t is a sample time, and a and b are any positive integers.

$${f}_{on} = \frac{1}{2 N τ} ( a - b ) \qquad Expression 1$$

$${f}_{off} = \frac{1}{2 N τ} ( a + b ) \qquad Expression 2$$

In some implementations, the “on-line” and “off-line” frequencies are constrained by Expressions 3, 4, and 5, where v is a velocity of the laser spot on the ground, r is the laser spot radius on the ground, fₕₚ is the frequency of the high-pass filter 1082, and fₗₚ is the frequency of the low-pass filters 1086.

$${f}_{on} , {f}_{off} > {f}_{lp} > \frac{v}{r} \qquad Expression 3$$

$${f}_{hp} > \frac{v}{r} \qquad Expression 4$$

$$‖ {f}_{on} - {f}_{off} ‖ > {f}_{lp} > \frac{v}{r} \qquad Expression 5$$

In some implementations, Expressions 1 and 2 provide sufficient noise suppression for stationary implementations while Expressions 3, 4, and 5 provide greater noise suppression that may be useful for mobile, dynamic environments, such as aircraft-mounted systems.

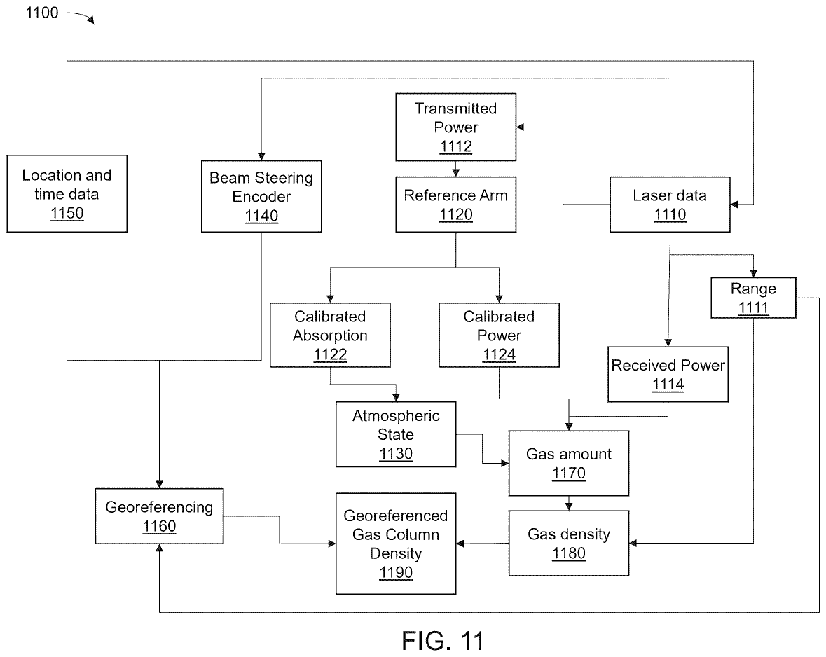

FIG. 11 is a flow diagram of an example system 1100 for open-path gas detection and quantification. The system 1100 may be similar to the system 200 of FIG. 2, with the system 1100 including data and control signals not illustrated in FIG. 2.

The system includes laser data 1110 from controller 1080, including transmitted power 1112, calibrated absorption 1122, and received power 1114 of a first laser beam and a second laser beam and up to n total laser beams. The transmitted power 1112 of the first laser beam and the second laser beam up to n total laser beams wavelengths is provided to a reference arm 1120. The reference arm 1120 may include reference sensors and a gas reference cell for measuring the transmitted power 1112 such as the power reference sensor 270b, the gas cell 272 and the gas reference sensor 270c of FIG. 2. The reference arm 1120 may provide a calibrated absorption 1122 and a calibrated power 1124 of the transmitted power 1112. The calibrated absorption 1122 may be modified using an atmospheric state 1130. The atmospheric state 1130 may include temperature, humidity, aerosols, and other data affecting absorption of light of the calibrated absorption 1122. In one implementation when the absorption is small, the calibrated absorption due to methane can be expressed as in Expression 6.

$$( 1 - \frac{{B}_{2}}{{B}_{1}} \frac{{C}_{1}}{{C}_{2}} ) {C}_{0} / ( 1 - \frac{{A}_{2}}{{A}_{1}} \frac{{C}_{1}}{{C}_{2}} ) \qquad Expression 6$$

In Expression 6, B is the measured signal from a received power detector (e.g., received power sensor 270a), C is the measured signal from a power reference detector (e.g., the power reference sensor 270b), A is the measured signal from a gas reference detector (e.g., the gas reference sensor 270c), C₀ is the absorption calibration constant, C₁ is a measured signal corresponding to the on laser (on-wavelength laser) and C₂ is a measured signal corresponding to the off laser (off-wavelength laser).

The laser data 1110 is also used to determine a range 1111, or distance to target. The range 1111 is determined using a time of flight of the combined laser beam. The calibrated absorption 1122 as modified using the atmospheric state 1130, the calibrated power 1124 and the received power 1114 can be used to determine an amount of gas 1170 between the system and the target, as discussed herein. The range 1111 and the amount of gas 1170 can be used to determine a gas density 1180 between the system and the target.

The laser data may be time stamped using location and time data 1150 to correlate the laser data 1110 with a geolocation. The location and time data 1150 may include a roll, pitch, yaw, latitude, longitude, and time. The location and time data 1150 may represent a location and time of a system (e.g., the system 200) and may be associated with measurements taken by the system at the location and time. The location and time data 1150 can be combined with beam steering encoder angle 1140 to determine a ground location and time of the laser beam in georeferencing 1160. The beam steering 1140 can be based on the transmission of the laser from the laser data 1110. The georeferencing 1160 may include a ground location and time of the combined laser beam, based on the range 1111. In an example, the georeferencing 1160 includes a ground location, angle and time of a column corresponding to a path of the combined laser beam.

The georeferencing 1160 and the gas density 1180 can be used to determine a georeferenced gas column density 1190. The georeferenced gas column density 1190 for multiple different samples in an area can be used to generate a map of georeferenced gas column density showing the spatial distribution of gas concentrations in the area.

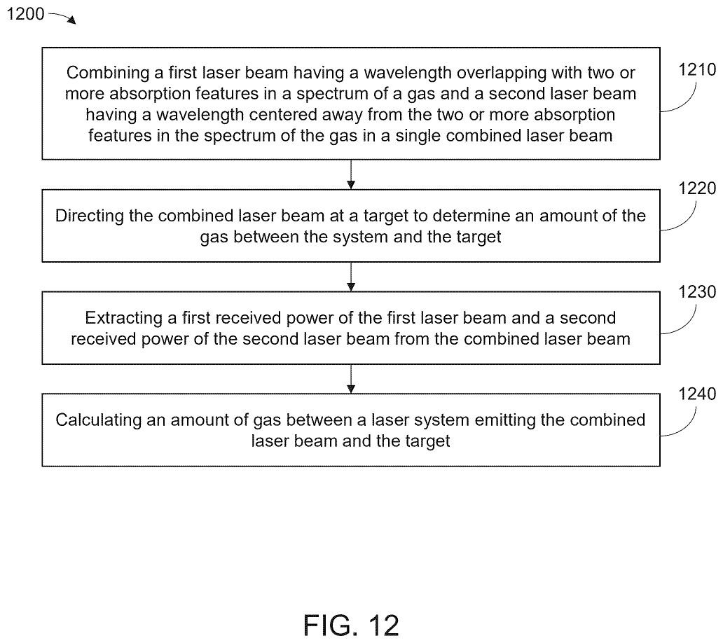

FIG. 12 is a flowchart illustrating operations of a method 1200 for open-path gas detection and quantification. The method may include more, fewer, or different operations than shown. The operations may be performed in the order shown, in a different order, or concurrently.

At operation 1210, a first laser beam having a wavelength overlapping with two or more absorption features in a spectrum of a gas and a second laser beam having a wavelength centered away from the two or more absorption features in the spectrum of the gas are combined in a single combined laser beam.

At operation 1220, the combined laser beam is directed at a target. The target may be any object off of which the combined laser beam is reflected or scattered. The target may be selected, or may be any surface or object off of which the combined laser beam happens to be reflected.

At operation 1230, a first received power of the first laser beam and a second received power of the second laser beam are extracted from the combined reflected light. An example of extracting powers of different laser beams from a combined laser beam is described in FIG. 10.

At operation 1240, an amount of gas between a laser system emitting the combined laser beam and the target is calculated based on the first received power of the first laser beam and the second received power of the second laser beam. The second laser beam can be used as a reference beam to account for loss of power due to factors other than the amount of gas. Thus, the difference between the first received power of the first laser beam and the second received power of the second laser beam is due to absorption of the first laser beam by the amount of the gas. In some implementations, the method 1200 includes associating the amount of the gas between the system and the target with a geolocation of the target. The method 1200 can include generating a map of amounts of the gas, or densities of the gas, within a geographic area including the target.

In some implementations, the method 1200 includes extracting a first transmitted power of the first laser beam and a second transmitted power of the second laser beam. The first transmitted power of the first laser beam and the second transmitted power of the second laser beam can be extracted using a reference sensor such as the power reference sensor 270b.

In some implementations, the method 1200 includes calculating an amount of gas between the system and the target by determining a first difference between the first transmitted power of the first laser beam and the first received power of the first laser beam and a second difference between the second transmitted power of the second laser beam and the second received power of the second laser beam. As discussed herein, the second laser beam can be used as a reference beam, such that the second difference between the second transmitted power of the second laser beam and the second received power of the second laser beam represents a power loss due to factors other than the amount of gas such as aerosols, humidity, ground reflectivity, ground scatter and distance. The first difference between the first transmitted power of the first laser beam and the first received power of the first laser beam includes the power loss due to the other factors as well as absorption by the gas. By comparing the first difference to the second difference, an amount of the first difference attributable to the gas can be determined, allowing for determination of the amount of the gas.

In some implementations, the method 1200 includes adding a third laser beam having a third wavelength different from the first wavelength and the second wavelength to the combined laser beam, wherein the third wavelength does not overlap with any absorption features in the spectrum of the gas, or is centered away from the one or more absorption features. Just as the second laser beam can serve as a reference beam, the third laser beam can serve as a reference beam to further refine an accuracy of the calculation of the amount of the gas. For example, differences in power loss between the first laser beam and the second laser beam due to aerosols and humidity can be detected using the third laser beam, reducing an effect of the specific wavelength of the second laser beam upon the calculation of the amount of the gas.

In some implementations, the method 1200 includes combining light from the first laser emitter and light from a fourth laser emitter to form the first laser beam, wherein the fourth laser emitter has a same wavelength as the first laser emitter. In this way, a power of the first laser beam can be increased relative to use of a single laser emitter. An example of a system for combining the light from the first laser emitter and the light from the fourth laser emitter is shown in FIG. 8. Similarly, light from multiple laser emitters can be used to form the second laser beam and/or the third laser beam.

In some implementations, the method 1200 includes measuring, by a first monitor, a power of the combined laser beam. An example of the first monitor is the power reference sensor 270b of FIG. 2. In some implementations, measuring, by the first monitor, the power of the combined laser beam includes using a partial reflection of the combined laser beam. In an example, a flat cleaved end of an optical fiber carrying the combined laser beam causes the partial reflection, which partial reflection can be coupled into a reference arm. In some implementations, the method 1200 includes measuring, by a second monitor, the first wavelength of the first laser emitter and the second wavelength of the second laser emitter. An example of the second monitor is the gas reference sensor 270c of FIG. 2. In an example, the first absorption of the first laser emitter and the second absorption of the second laser emitter are measured in a relative fashion by measuring the power of the first and second laser beams after they have passed through a gas reference cell. In some implementations, measuring, by the second monitor, the first absorption of the first laser emitter and the second absorption of the second laser emitter includes measuring a modified power of the combined laser beam after the combined laser beam has passed through a reference cell containing the gas.

In some implementations, the system is deployed on (e.g., coupled to, mounted on, installed within) an aircraft, and the target is the ground. An example of such an implementation is illustrated in FIG. 1. The aircraft may be a light aircraft, unmanned aerial vehicle (UAV), or drone. As discussed herein, the system may be resistant to temperature and mechanical disruptions caused by the aircraft, providing robust measurement of the amount of gas when coupled to the aircraft.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system for open path gas detection, comprising:
a first laser emitter having a first wavelength overlapping with two or more absorption features in a spectrum of a gas;
a second laser emitter having a second wavelength centered away from the two or more absorption features in the spectrum of the gas, wherein a first laser beam including light from the first laser emitter and a second laser beam including light from the second laser emitter are made sufficiently collinear in a single combined laser beam, wherein the combined laser beam is directed at a target to determine an amount of the gas between the system and the target; and
signal processing circuitry configured to extract a first received power of the first laser beam and a second received power of the second laser beam from the combined laser beam.

2. The system of claim 1, further comprising a processor which executes instructions to calculate an amount of gas between the system and the target based on the first received power of the first laser beam and the second received power of the second laser beam.

3. The system of claim 2, wherein the processor associates the amount of the gas between the system and the target with a geolocation of the target.

4. The system of claim 1, wherein the signal processing circuitry is configured to extract a first transmitted power of the first laser beam and a second transmitted power of the second laser beam.

5. The system of claim 4, further comprising a processor that executes instructions to calculate an amount of gas between the system and the target by determining a first difference between the first transmitted power of the first laser beam and the first received power of the first laser beam and a second difference between the second transmitted power of the second laser beam and the second received power of the second laser beam.

6. The system of claim 1, further comprising a third laser emitter having a third wavelength different from the first wavelength and the second wavelength, wherein the third wavelength is centered away from the first wavelength and the second wavelength.

7. The system of claim 1, wherein the first laser beam or the second laser beam includes light from an additional laser emitter having the same wavelength as the first laser or the second laser emitter, respectively, wherein the light from the additional laser emitter and the light from the first laser emitter or the second laser emitter are combined to form the first laser beam or the second laser beam, respectively.

8. The system of claim 1, further comprising a first monitor configured to measure a power of the combined laser beam.

9. The system of claim 8, wherein the first monitor is configured to measure the power of the combined laser beam over a first wavelength range of the first laser emitter and over a second wavelength range of the second laser emitter.

10. The system of claim 8, wherein the first monitor is configured to measure the power of the combined laser beam using a partial reflection of the combined laser beam.

11. The system of claim 1, further comprising a second monitor configured to measure a first calibrated absorption of the first laser beam and a second calibrated absorption of the second laser beam.

12. The system of claim 11, wherein the second monitor is configured to measure the first calibrated absorption of the first laser beam and the second calibrated absorption of the second laser beam by measuring a modified power of the combined laser beam after the combined laser beam has passed through a reference cell containing a sample of the gas.

13. The system of claim 1, wherein the system is deployed on an aircraft, and wherein the target is the ground.

14. A method for open path gas detection, comprising:
combining a first laser beam having a first wavelength overlapping with two or more absorption features in a spectrum of a gas and a second laser beam having a second wavelength centered away from the two or more absorption features in the spectrum of the gas in a single combined laser beam;
directing the combined laser beam at a target; and
extracting a first received power of first reflected light corresponding to the first laser beam and a second received power of second reflected light corresponding to the second laser beam from the combined laser beam.

15. The method of claim 14, further comprising calculating an amount of gas between a laser system emitting the combined laser beam and the target based on the first received power of the first reflected light and the second received power of the second reflected light.

16. The method of claim 15, further comprising associating the amount of the gas between the system and the target with a geolocation of the target.

17. The method of claim 14, further comprising extracting a first transmitted power of the first laser beam and a second transmitted power of the second laser beam.

18. The method of claim 17, further comprising calculating an amount of gas between the system and the target by determining a first difference between the first transmitted power of the first laser beam and the first received power of the first laser beam and a second difference between the second transmitted power of the second laser beam and the second received power of the second laser beam.

19. The method of claim 14, further comprising adding a third laser beam having a third wavelength different from the first wavelength and the second wavelength to the combined laser beam, wherein the third wavelength is centered away from the two or more absorption features in the spectrum of the gas.

20. The method of claim 14, further comprising combining light from an additional laser emitter and light from the first laser emitter or the second laser emitter to form the first laser beam or the second laser beam, respectively, wherein the additional laser emitter has the same wavelength as the first laser emitter or the second laser emitter, respectively.

21. The method of claim 14, further comprising measuring, by a first monitor, a power of the combined laser beam.

22. The method of claim 21, wherein measuring, by the first monitor, the power of the combined laser beam over a first wavelength range of the first laser beam and over a second wavelength range of the second laser beam.

23. The method of claim 21, wherein measuring, by the first monitor, the power of the combined laser beam includes using a partial reflection of the combined laser beam.

24. The method of claim 14, further comprising measuring, by a second monitor, a first calibrated absorption of the first laser beam and a second calibrated absorption of the second laser beam.

25. The method of claim 24, wherein measuring, by the second monitor, the first calibrated absorption of the first laser beam and the second calibrated absorption of the second laser beam includes measuring a modified power of the combined laser beam after the combined laser beam has passed through a reference cell containing a sample of the gas.

26. The method of claim 14, wherein the system is deployed on an aircraft, and wherein the target is the ground.
